(19) United States
(12) Patent Application Publication
(10) Pub. No.: US 2018/0206187 A1
(43) Pub. Date: Jul. 19, 2018

(54) METHOD AND APPARATUS FOR SAVING POWER IN A GATEWAY NETWORK

(71) Applicant: Nokia Technologies Oy, Espoo (FI)

(72) Inventors: Teemu Ilmari SAVOLAINEN, Nokia (FI); Simo VEIKKOLAINEN, Masala (FI); Markus ISOMÄKI, Espoo (FI); István BESZTERI, Espoo (FI); Pekka TALMOLA, Turku (FI); Vlad STIRBU, Tampere (FI)

(21) Appl. No.: 15/743,372

(22) PCT Filed: Jul. 10, 2015
(86) PCT No.: PCT/IB2015/055239

§ 371 Date: Jan. 10, 2018

(51) Int. Cl. H04W 52/02; H04L 12/66

(52) U.S. Cl. CPC H04W 52/0203; H04W 52/0261; H04L 12/66; H04W 52/0219

(57) ABSTRACT

Embodiments are disclosed for saving power in a gateway network comprising a plurality of nodes including a gateway device and one or more endpoint devices. In the context of a method, an example embodiment includes determining a mode of operation that results in optimal power utilization of at least one node, and determining whether a current mode of operation comprises the mode of operation that results in optimal power utilization of the node. In response to determining that the current mode of operation does not, the method further includes generating a mode switch message based on the mode of operation that results in optimal power utilization of the node, and causing transmission of the mode switch message to a first subset of the one or more endpoint devices. A corresponding apparatus and computer program product are also provided.

### TECHNOLOGICAL FIELD

Example embodiments of the present invention relate generally to network node connectivity and, more particularly, to a method and apparatus for saving power in a network comprising a plurality of nodes connected to a gateway device.

### BACKGROUND

The Internet of Things (IoT), which refers to the interconnection of uniquely identifiable embedded computing devices within the Internet infrastructure, is quickly growing, and some estimates suggest that by 2020 there will be 50 billion Internet connected devices. As part of this growth, emerging IoT platforms now provide the technical infrastructure to build and utilize autonomous wireless sensor devices.

In some examples, this infrastructure enables the creation of local networks of endpoint devices (e.g., wireless sensor devices) that are connected to a gateway device. A network comprising a plurality of nodes of this nature (e.g., a network including one or more endpoint devices and a gateway device) will hereinafter be referred to as a gateway network. The gateway device of a gateway network may in turn connect the gateway network to another network (e.g., the Internet). Gateway networks are utilized today in a wide variety of situations. For instance, one example gateway network may be a body area network used for monitoring a patient's medical state. The endpoint devices that comprise the nodes in this example may be low power sensors attached to the body (e.g., EKG monitors or the like) and the gateway device may be another portable device carried by the patient, such as a wrist device. A typical radio technology used between the endpoint devices and the gateway device is Bluetooth™ Low Energy (BLE).

Normally, gateway networks of this nature are designed to minimize the energy consumption by the endpoint devices; as a result, however, the gateway device serving the endpoint devices necessarily consumes more power than the endpoint devices. For instance, in one such design, the endpoint devices are configured to activate their radio communication capabilities only when they have data to send, and are not, in general, listening for transmissions from the gateway device or from other endpoint devices. On the other hand, the gateway device is listening for the endpoints' communications at (nearly) all times, because the endpoint devices could conceivably send data at any time.

In this fashion, many BLE-based systems are designed so that the endpoint devices send their data asynchronously using BLE's advertisement packets, and only occasionally listen to incoming communication (e.g., right after they have transmitted an advertisement packet). The gateway device must listen continuously as the advertisement packets may arrive at any point in time. The difference in power consumption between these two modes of operation is huge: with the same battery, if a send-only device could run for years even with a relatively high sending rate (once a second), the listen-at-all-times device would likely run out of battery power in a matter of days or weeks. As a result of this fact, gateways devices effectively have to be grid powered in order to accommodate the high power consumption required by being in “listen” mode all the time.

### BRIEF SUMMARY

In view of the above, there are situations when a gateway device may be at risk of running out of power before any of the endpoint devices. If the gateway device runs out of power, however, not only can the gateway device itself no longer be used, but the endpoint devices also lose their network connectivity.

One attempt to mitigate the effects of power consumption on gateway devices was made in https://www.ietf.org/archive/id/draft-savolainen-6lo-optimal-transmission-window-00.txt. As described therein, a gateway device could have active BLE connections to each of the endpoint devices and thus could reduce its rate of power consumption by sleeping between connection intervals. However, maintaining active connections between nodes is more resource-consuming than relying on connectionless transmissions (in particular, it requires a larger amount of random access memory), and it also adds an additional degree of complexity and connection setup overhead to the local network. Furthermore, many BLE chipsets limit the maximum number of parallel connections available to a device, so in practical effect a gateway device can serve many more advertisement-using nodes than it could serve when using a connection-based system. These facts make connection-based data collection systems harder to implement in practice. Connected mode also requires endpoint devices to have bidirectional transmission capacity, whereas those endpoint devices could be in a sending-only mode in an advertisement-based system (which is cheaper).

Example embodiments described herein utilize various means to address the need to extend the functional lifetime of gateway networks that do not suffer from these drawbacks. For instance, example embodiments describe ways to change the mode of operation of the gateway device and the endpoint devices to temporarily preserve the gateway device's battery power at the expense of one or more of the endpoint devices. This is possible using BLE or other similar radio technologies where the lengths of the sending and listening duty cycles are adjustable.

In a first example embodiment, a method is provided for saving power in a gateway network comprising a plurality of nodes including a gateway device and one or more endpoint devices. The methods may include determining, by a processor of the gateway device, a mode of operation of the gateway network that results in optimal power utilization of at least one of the plurality of nodes, and determining, by the processor of the gateway device, whether a current mode of operation of the gateway network comprises the mode of operation of the gateway network that results in optimal power utilization of at least one of the plurality of nodes. In response to determining that the current mode of operation of the gateway network does not comprise the mode of operation of the gateway network that results in optimal power utilization of at least one of the plurality of nodes, these example methods may include generating, by the processor of the gateway device, a mode switch message based on the mode of operation of the gateway network that results in optimal power utilization of the at least one of the plurality of nodes, and causing transmission of the mode switch message to a first subset of the one or more endpoint devices.

In some embodiments, the method includes identifying, by the processor of the gateway device, a battery power status of the gateway device. In these embodiments, the battery power status of the gateway device indicates at least one of a battery power level of the gateway device, a rate of battery consumption of the gateway device, or an estimated battery lifetime of the gateway device. Furthermore, in these embodiments, the determination of the mode of operation of the gateway network that results in optimal power utilization of the least one of a plurality of nodes is based on the identified battery power status of the gateway device.

In an instance in which the battery power status of the gateway device indicates a battery power level of the gateway device, the determination of the mode of operation of the gateway network that results in optimal power utilization of the at least one of the plurality of nodes may be based on the indicated battery power level of the gateway device.

Some such embodiments may further include determining, by the processor of the gateway device, that the battery power level of the gateway device is below a first predetermined threshold, wherein the determination of the mode of operation of the gateway network that results in optimal power utilization of the at least one of the plurality of nodes is based on the determination the battery power level of the gateway device is below the first predetermined threshold.

Other such embodiments may include receiving, by the communications circuitry of the gateway device, one or more messages indicating battery power statuses of a second subset of the one or more endpoint devices, wherein the battery power status of each particular endpoint device of the second subset of endpoint devices indicates at least one of a battery power level of the endpoint device, a rate of battery consumption of the endpoint device, or an estimated battery lifetime of the particular endpoint device, and wherein the determination of the mode of operation of the gateway network that results in optimal power utilization of the at least one of the plurality of nodes is further based on the received battery power statuses of the second subset of the one or more endpoint devices. In this regard, example methods may further include, in an instance in which the battery power status of the gateway device indicates a battery power level of the gateway device and the battery power statuses of the second subset of the one or more to endpoint devices indicate battery power levels of the second subset of the one or more endpoint devices, generating ratios of the battery power level of the gateway device to the battery power levels of the second subset of the one or more endpoint devices, and determining that at least one of the generated ratios of the generated ratios is below a second predetermined threshold, wherein the determination of the mode of operation of the gateway network that results in optimal power utilization of the at least one of the plurality of nodes is based on the determination that at least one of the generated ratios is below the second predetermined threshold.

In yet other such embodiments, example methods may include identifying, by the gateway device, capabilities of a third subset of the one or more endpoint devices, wherein the determination of the mode of operation of the gateway network that results in optimal power utilization of the at least one of the plurality of nodes is further based on the identified capabilities of the third subset of the one or more endpoint devices.

Still further, other examples of such embodiments may include identifying, by the gateway device, a set of most important functions of the gateway network, wherein the determination of the mode of operation of the gateway network that results in optimal power utilization of the at least one of the plurality of nodes is further based on the identified set of the most important functions of the gateway network.

In some embodiments, the mode switch message instructs the first subset of the one or more endpoint devices to operate in polling mode. In some embodiments, the first subset of the one or more endpoint devices comprises a target endpoint device, and the mode switch message instructs the target endpoint device to operate as a collector device. In one such example embodiment, the method may further include identifying, by the processor of the gateway device, that the target endpoint device is capable of acting as a collector device and that the target endpoint device has a battery power level greater than a battery power threshold, wherein the battery power threshold comprises a battery power level predetermined to be sufficient for a collector device, wherein the mode switch message is transmitted to the target endpoint device in response to identifying that the target endpoint device is capable of acting as a collector device and that the target endpoint device has a battery power level greater than the battery power threshold.

In a second example embodiment, an apparatus is provided for saving power in a gateway network comprising a plurality of nodes including a gateway device and one or more endpoint devices. The apparatus includes at least one processor and at least one memory including computer program code, the at least one memory and the computer program code configured to, with the at least one processor, cause the apparatus to determine a mode of operation of the gateway network that results in optimal power utilization of at least one of the plurality of nodes, and determine whether a current mode of operation of the gateway network comprises the mode of operation of the gateway network that results in optimal power utilization of at least one of the plurality of nodes. The at least one memory and the computer program code are further configured to, with the at least one processor, cause the apparatus to, in response to determining that the current mode of operation of the gateway network does not comprise the mode of operation of the gateway network that results in optimal power utilization of at least one of the plurality of nodes, generate a mode switch message based on the mode of operation of the gateway network that results in optimal power utilization of the at least one of the plurality of nodes, and transmit the mode switch message to a first subset of the one or more endpoint devices.

In some embodiments, the at least one memory and the computer program code may be further configured to, with the at least one processor, cause the apparatus to identify a battery power status of the gateway device. In these embodiments, the battery power status of the gateway device indicates at least one of a battery power level of the gateway device, a rate of battery consumption of the gateway device, or an estimated battery lifetime of the gateway device. Furthermore, in these embodiments, the determination of the mode of operation of the gateway network that results in optimal power utilization of the least one of a plurality of nodes is based on the identified battery power status of the gateway device.

In an instance in which the battery power status of the gateway device indicates a battery power level of the gateway device, the at least one memory and the computer program code may be further configured to, with the at least one processor, cause the apparatus to determine the mode of operation of the gateway network that results in optimal power utilization of the at least one of the plurality of nodes based on the indicated battery power level of the gateway device.

In some embodiments, the at least one memory and the computer program code are further configured to, with the at least one processor, cause the apparatus to determine that the battery power level of the gateway device is below a first predetermined threshold, wherein the determination of the mode of operation of the gateway network that results in optimal power utilization of the at least one of the plurality of nodes is based on the determination the battery power level of the gateway device is below the first predetermined threshold.

In some such embodiments, the at least one memory and the computer program code are further configured to, with the at least one processor, cause the apparatus to receive one or more messages indicating battery power statuses of a second subset of the one or more endpoint devices, wherein the battery power status of each particular endpoint device of the second subset of endpoint devices indicates at least one of a battery power level of the endpoint device, a rate of battery consumption of the endpoint device, or an estimated battery lifetime of the particular endpoint device, and wherein the at least one memory and the computer program code are further configured to, with the at least one processor, cause the apparatus to determine the mode of operation of the gateway network that results in optimal power utilization of the at least one of the plurality of nodes based on the received battery power statuses of the second subset of the one or more endpoint devices. In this regard, the at least one memory and the computer program code may be further configured to, with the at least one processor, cause the apparatus to, in an instance in which the battery power status of the gateway device indicates a battery power level of the gateway device and the battery power statuses of the second subset of the one or more to endpoint devices indicate battery power levels of the second subset of the one or more endpoint devices, generate ratios of the battery power level of the gateway device to the battery power levels of the second subset of the one or more endpoint devices, and determine that at least one of the generated ratios of the generated ratios is below a second predetermined threshold, wherein the at least one memory and the computer program code are further configured to, with the at least one processor, cause the apparatus to determine the mode of operation of the gateway network that results in optimal power utilization of the at least one of the plurality of nodes is based on the determination that at least one of the generated ratios is below the second predetermined threshold.

In other such embodiments, the at least one memory and the computer program code are further configured to, with the at least one processor, cause the apparatus to identify capabilities of a third subset of the one or more endpoint devices, wherein the at least one memory and the computer program code are further configured to, with the at least one processor, cause the apparatus to determine the mode of operation of the gateway network that results in optimal power utilization of the at least one of the plurality of nodes based on the identified capabilities of the third subset of the one or more endpoint devices.

In still other such embodiments, the at least one memory and the computer program code are further configured to, with the at least one processor, cause the apparatus to identify a set of most important functions of the gateway network, wherein the at least one memory and the computer program code are further configured to, with the at least one processor, cause the apparatus to determine the mode of operation of the gateway network that results in optimal power utilization of the at least one of the plurality of nodes based on the identified set of the most important functions of the gateway network.

In some embodiments, the mode switch message instructs the first subset of the one or more endpoint devices to operate in polling mode. In other embodiments, the first subset of the one or more endpoint devices comprises a target endpoint device, and the mode switch message instructs the target endpoint device to operate as a collector device. In some such embodiments, the at least one memory and the computer program code are further configured to, with the at least one processor, cause the apparatus to identify that the target endpoint device is capable of acting as a collector device and that the target endpoint device has a battery power level greater than a battery power threshold, wherein the battery power threshold comprises a battery power level predetermined to be sufficient for a collector device, wherein the at least one memory and the computer program code are further configured to, with the at least one processor, cause the apparatus to transmit the mode switch message to the target endpoint device in response to identifying that the target endpoint device is capable of acting as a collector device and that the target endpoint device has a battery power level greater than the battery power threshold.

In a third example embodiment, a computer program product is provided for saving power in a gateway network comprising a plurality of nodes including a gateway device and one or more endpoint devices. The computer program product includes at least one non-transitory computer-readable storage medium having computer-executable program code portions stored therein, the computer-executable program code portions comprising program code instructions that, when executed, cause an apparatus to determine a mode of operation of the gateway network that results in optimal power utilization of at least one of the plurality of nodes, and determine whether a current mode of operation of the gateway network comprises the mode of operation of the gateway network that results in optimal power utilization of at least one of the plurality of nodes. The program code instructions, when executed, further cause the apparatus to, in response to determining that the current mode of operation of the gateway network does not comprise the mode of operation of the gateway network that results in optimal power utilization of at least one of the plurality of nodes, generate a mode switch message based on the mode of operation of the gateway network that results in optimal power utilization of the at least one of the plurality of nodes, and transmit the mode switch message to a first subset of the one or more endpoint devices.

In some embodiments, the program code instructions, when executed, further cause the apparatus to identify a battery power status of the gateway device. In these embodiments, the battery power status of the gateway device indicates at least one of a battery power level of the gateway device, a rate of battery consumption of the gateway device, or an estimated battery lifetime of the gateway device. Furthermore, in these embodiments, the determination of the mode of operation of the gateway network that results in optimal power utilization of the least one of a plurality of nodes is based on the identified battery power status of the gateway device.

In an instance in which the battery power status of the gateway device indicates a battery power level of the gateway device, the program code instructions, when executed, may further cause the apparatus to determine the mode of operation of the gateway network that results in optimal power utilization of the at least one of the plurality of nodes based on the indicated battery power level of the gateway device.

In some embodiments, the program code instructions, when executed, further cause the apparatus to determine that the battery power level of the gateway device is below a first predetermined threshold, wherein the determination of the mode of operation of the gateway network that results in optimal power utilization of the at least one of the plurality of nodes is based on the determination the battery power level of the gateway device is below the first predetermined threshold.

In some such embodiments, the program code instructions, when executed, further cause the apparatus to receive one or more messages indicating battery power statuses of a second subset of the one or more endpoint devices, wherein the battery power status of each particular endpoint device of the second subset of endpoint devices indicates at least one of a battery power level of the endpoint device, a rate of battery consumption of the endpoint device, or an estimated battery lifetime of the particular endpoint device, and wherein the program code instructions, when executed, further cause the apparatus to determine the mode of operation of the gateway network that results in optimal power utilization of the at least one of the plurality of nodes based on the received battery power statuses of the second subset of the one or more endpoint devices. In this regard, the program code instructions, when executed, further cause the apparatus to, in an instance in which the battery power status of the gateway device indicates a battery power level of the gateway device and the battery power statuses of the second subset of the one or more to endpoint devices indicate battery power levels of the second subset of the one or more endpoint devices, generate ratios of the battery power level of the gateway device to the battery power levels of the second subset of the one or more endpoint devices, and determine that at least one of the generated ratios of the generated ratios is below a second predetermined threshold, wherein the program code instructions, when executed, further cause the apparatus to determine the mode of operation of the gateway network that results in optimal power utilization of the at least one of the plurality of nodes is based on the determination that at least one of the generated ratios is below the second predetermined threshold.

In other such embodiments, the program code instructions, when executed, further cause the apparatus to identify capabilities of a third subset of the one or more endpoint devices, wherein the program code instructions, when executed, further cause the apparatus to determine the mode of operation of the gateway network that results in optimal power utilization of the at least one of the plurality of nodes based on the identified capabilities of the third subset of the one or more endpoint devices.

In still other such embodiments, the program code instructions, when executed, further cause the apparatus to identify a set of most important functions of the gateway network, wherein the program code instructions, when executed, further cause the apparatus to determine the mode of operation of the gateway network that results in optimal power utilization of the at least one of the plurality of nodes based on the identified set of the most important functions of the gateway network.

In some embodiments, the mode switch message instructs the first subset of the one or more endpoint devices to operate in polling mode. In other embodiments, the first subset of the one or more endpoint devices comprises a target endpoint device, and the mode switch message instructs the target endpoint device to operate as a collector device. In some such embodiments, the program code instructions, when executed, further cause the apparatus to identify that the target endpoint device is capable of acting as a collector device and that the target endpoint device has a battery power level greater than a battery power threshold, wherein the battery power threshold comprises a battery power level predetermined to be sufficient for a collector device, wherein the program code instructions, when executed, further cause the apparatus to transmit the mode switch message to the target endpoint device in response to identifying that the target endpoint device is capable of acting as a collector device and that the target endpoint device has a battery power level greater than the battery power threshold.

In a fourth example embodiment, an apparatus is provided for saving power in a gateway network comprising a plurality of nodes including a gateway device and one or more endpoint devices. The apparatus includes means for determining a mode of operation of the gateway network that results in optimal power utilization of at least one of the plurality of nodes, and means for determining whether a current mode of operation of the gateway network comprises the mode of operation of the gateway network that results in optimal power utilization of at least one of the plurality of nodes. In response to determining that the current mode of operation of the gateway network does not comprise the mode of operation of the gateway network that results in optimal power utilization of at least one of the plurality of nodes, the apparatus includes means for generating a mode switch message based on the mode of operation of the gateway network that results in optimal power utilization of the at least one of the plurality of nodes, and means for causing transmission of the mode switch message to a first subset of the one or more endpoint devices.

In some embodiments, the apparatus includes means for identifying a battery power status of the gateway device. In these embodiments, the battery power status of the gateway device indicates at least one of a battery power level of the gateway device, a rate of battery consumption of the gateway device, or an estimated battery lifetime of the gateway device. Furthermore, in these embodiments, the determination of the mode of operation of the gateway network that results in optimal power utilization of the least one of a plurality of nodes is based on the identified battery power status of the gateway device.

In an instance in which the battery power status of the gateway device indicates a battery power level of the gateway device, the determination of the mode of operation of the gateway network that results in optimal power utilization of the at least one of the plurality of nodes may be based on the indicated battery power level of the gateway device.

Some such embodiments may further include means for determining that the battery power level of the gateway device is below a first predetermined threshold, wherein the determination of the mode of operation of the gateway network that results in optimal power utilization of the at least one of the plurality of nodes is based on the determination the battery power level of the gateway device is below the first predetermined threshold.

Other such embodiments may include means for receiving one or more messages indicating battery power statuses of a second subset of the one or more endpoint devices, wherein the battery power status of each particular endpoint device of the second subset of endpoint devices indicates at least one of a battery power level of the endpoint device, a rate of battery consumption of the endpoint device, or an estimated battery lifetime of the particular endpoint device, and wherein the determination of the mode of operation of the gateway network that results in optimal power utilization of the at least one of the plurality of nodes is further based on the received battery power statuses of the second subset of the one or more endpoint devices. In this regard, an example apparatus may further include, in an instance in which the battery power status of the gateway device indicates a battery power level of the gateway device and the battery power statuses of the second subset of the one or more to endpoint devices indicate battery power levels of the second subset of the one or more endpoint devices, means for generating ratios of the battery power level of the gateway device to the battery power levels of the second subset of the one or more endpoint devices, and means for determining that at least one of the generated ratios of the generated ratios is below a second predetermined threshold, wherein the determination of the mode of operation of the gateway network that results in optimal power utilization of the at least one of the plurality of nodes is based on the determination that at least one of the generated ratios is below the second predetermined threshold.

In yet other such embodiments, the apparatus may include means for identifying capabilities of a third subset of the one or more endpoint devices, wherein the determination of the mode of operation of the gateway network that results in optimal power utilization of the at least one of the plurality of nodes is further based on the identified capabilities of the third subset of the one or more endpoint devices.

Still further, other examples of such embodiments may include means for identifying a set of most important functions of the gateway network, wherein the determination of the mode of operation of the gateway network that results in optimal power utilization of the at least one of the plurality of nodes is further based on the identified set of the most important functions of the gateway network.

In some embodiments, the mode switch message instructs the first subset of the one or more endpoint devices to operate in polling mode. In some embodiments, the first subset of the one or more endpoint devices comprises a target endpoint device, and the mode switch message instructs the target endpoint device to operate as a collector device. In one such example embodiment, the apparatus may further include means for identifying that the target endpoint device is capable of acting as a collector device and that the target endpoint device has a battery power level greater than a battery power threshold, wherein the battery power threshold comprises a battery power level predetermined to be sufficient for a collector device, wherein the mode switch message is transmitted to the target endpoint device in response to identifying that the target endpoint device is capable of acting as a collector device and that the target endpoint device has a battery power level greater than the battery power threshold.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings, which are not necessarily drawn to scale, and wherein:

FIG. 1 illustrates a block diagram of an apparatus that may be specifically configured in accordance with example embodiments of the present invention;

FIG. 2 illustrates a schematic representation of a normal mode of operation of a gateway network, in accordance with example embodiments of the present invention;

FIG. 3 illustrates a schematic representation of a polling mode of operation of a gateway network, in accordance with example embodiments of the present invention;

FIG. 4 illustrates a schematic representation of a polling-from-collector mode of operation of a gateway network, in accordance with example embodiments of the present invention;

FIG. 5 illustrates a flowchart describing example operations for optimizing the mode of operation of a gateway network, in accordance with example embodiments of the present invention; and

FIG. 6 illustrates a flowchart describing example operations for determining a mode of operation of the gateway network that results in optimal power utilization of at least one of the plurality of nodes, in accordance with example embodiments of the present invention.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention.

Additionally, as used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., a volatile or non-volatile memory device), can be differentiated from a “computer-readable transmission medium,” which refers to an electromagnetic signal.

Embodiments described herein demonstrate example methods, apparatuses, and computer program products that are designed to extend the functional lifetime of at least one of the plurality of nodes in a gateway network. For instance, when a gateway device faces an imminent a battery outage, the gateway device can indicate to the endpoint devices that it needs to switch to a power saving mode. In one example power saving mode, the gateway device can halt continuous listening and instead only receive data from endpoint devices by polling the endpoint devices, thus preserving the gateway device's power. The endpoint devices in this example would have to start listening for the polls, which would thus increase their power consumption.

In some embodiments, this problem can be mitigated by electing one of the endpoint devices as a collector device on behalf of the gateway device. By doing so, regular endpoint devices could continue their operation in the same fashion as in their normal mode, and the endpoint device that comprises the collector device would listen continuously, and receive and store the data received from the regular endpoint devices. The gateway device thus only needs to poll the collector device to receive the data provided by all of the endpoint devices. In some embodiments, this idea may be extended further, such that when the battery power level of a first collector device is drained below a predefined watermark, another endpoint device could be elected to become the collector device in place of the first collector device, thus enabling continued battery power conservation by the gateway device.

Furthermore, the gateway device could establish a BLE connection to the collector device, which would allow the gateway device to only activate its radio at negotiated connection intervals for polling the data (i.e., the gateway device could completely stop listening for advertisements and only use the connection to the collector device to retrieve data from all of the endpoint devices).

Details regarding how the gateway device instructs the endpoint devices to transition to different modes of operation, how the endpoint devices change their behavior in response to those instructions, and how the collector device is selected from among the endpoint devices are described below.

The methods described herein may be performed by (and the apparatuses, and computer program products may be embodied by) any of a variety of devices that are capable of connecting to one or more networks. For example, the devices may include any of a variety of battery-powered terminals, such as a wireless sensor device, portable digital assistant (PDA), mobile telephone, smartphone, smart watch, laptop computer, tablet computer, IoT devices of any kind (e.g., appliances, implanted devices, built-in devices, field-operable devices, or the like), or any combination of the aforementioned devices. Additionally or alternatively, the computing device may include fixed computing devices that have suitable wireless connectivity capabilities, such as a personal computer, a computer workstation, or the like. Still further, the method, apparatus, and computer program product of an example embodiment may be embodied by a networked device, such as a server or other network entity connected to a first public land mobile network (PLMN) and configured to control proximity-based communication by a plurality of UEs within the PLMN.

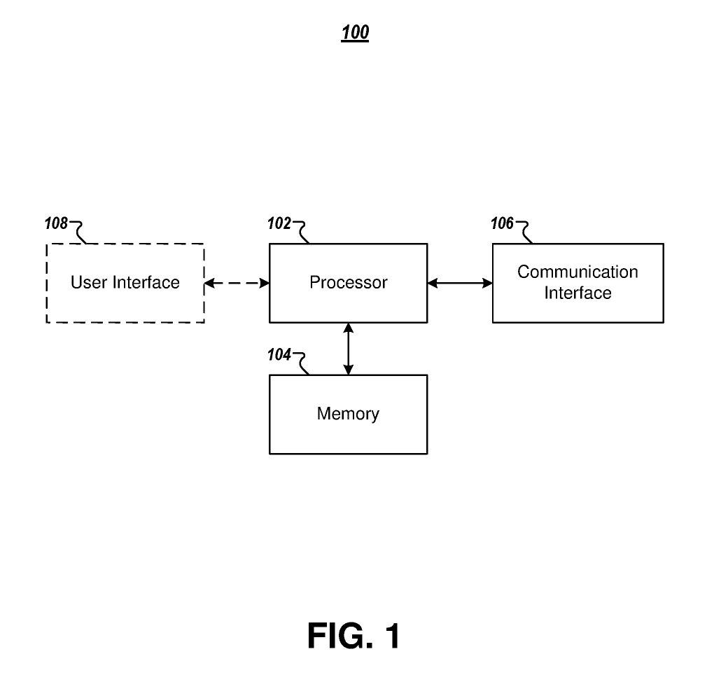

Referring now to FIG. 1, a block diagram illustrates an apparatus 100 that may embody an endpoint device or a gateway device. The apparatus 100 may include or otherwise be in communication with a processor 102, a memory 104, a communication interface 106, and a user interface 108. The apparatus 100 may be embodied by a computing device, such as a computer terminal. However, in some embodiments, the apparatus may be embodied as a chip or chip set. In other words, the apparatus 100 may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The apparatus 100 may therefore, in some cases, be configured to implement an embodiment of the present invention on a single chip or as a single “system on a chip.” As such, in some cases, a chip or chipset may constitute means for performing one or more operations for providing the functionalities described herein.

The processor 102 may be embodied in a number of different ways. For example, the processor 102 may be embodied as one or more of various hardware processing means such as a co-processor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 102 may include one or more processing cores configured to perform independently. A multi-core processor may enable multiprocessing within a single physical package. Additionally or alternatively, the processor 102 may include one or more processors configured in tandem via the bus to enable independent execution of instructions, pipelining, and/or multithreading.

In an example embodiment, the processor 102 may be configured to execute instructions stored in the memory 104 or otherwise accessible to the processor 102. Alternatively or additionally, the processor 102 may be configured to execute hard-coded functionality. As such, whether configured by hardware or software methods, or by a combination thereof, the processor 102 may represent an entity (e.g., physically embodied in circuitry) capable of performing operations according to an embodiment of the present invention while configured accordingly. Thus, for example, when the processor 102 is embodied as an ASIC, FPGA, or the like, the processor 102 may be specifically configured hardware for conducting the operations described herein. Alternatively, as another example, when the processor 102 is embodied as an executor of software instructions, the instructions may specifically configure the processor 102 to perform the algorithms and/or operations described herein when the instructions are executed. However, in some cases, the processor 102 may be a processor of a specific device (e.g., an endpoint device or a gateway device) configured to employ an embodiment of the present invention by further configuration of the processor by instructions for performing the algorithms and/or operations described herein. The processor 102 may include, among other things, a clock, an arithmetic logic unit (ALU), and logic gates configured to support operation of the processor 102.

In some embodiments, the processor 102 (and/or co-processor or any other processing circuitry assisting or otherwise associated with the processor) may be in communication with the memory 104 via a bus for passing information among components of the apparatus. The memory 104 may be non-transitory and may include, for example, one or more volatile and/or non-volatile memories. In other words, for example, the memory 104 may be an electronic storage device (e.g., a computer readable storage medium) comprising gates configured to store data (e.g., bits) that may be retrievable by a machine (e.g., a computing device like the processor). The memory 104 may be configured to store information, data, content, applications, instructions, or the like, for enabling the apparatus to carry out various functions in accordance with an example embodiment of the present invention. For example, the memory 104 could be configured to buffer input data for processing by the processor 102. Additionally or alternatively, the memory 104 could be configured to store instructions for execution by the processor 102.

Meanwhile, the communication interface 106 may be any means such as a device or circuitry embodied in either hardware or a combination of hardware and software that is configured to receive and/or transmit data from/to a plurality of wireless communication networks (e.g., access networks). In this regard, the communication interface 106 may include, for example, an antenna (or multiple antennas) and supporting hardware and/or software for enabling communications with a plurality of wireless communication networks. Additionally or alternatively, the communication interface 106 may include the circuitry for interacting with the antenna(s) to cause transmission of signals via the antenna(s) or to handle receipt of signals received via the antenna(s). In some environments, the communication interface 106 may additionally support wired communication. As such, for example, the communication interface 106 may include a communication modem and/or other hardware/software for supporting communication via cable, digital subscriber line (DSL), universal serial bus (USB), or other mechanisms. It should be understood that the communication interface 106 may, in various embodiments, include one or more proximity-based communication technologies that enable the apparatus 100 to communicate directly with other devices (e.g., when apparatus 100 embodies an endpoint device, the other devices may comprise other endpoint devices or the gateway device, and when apparatus 100 embodies the gateway device, the other devices may comprise any of the endpoint devices or a device outside the gateway network).

In embodiments where the apparatus 100 includes a user interface 108, user interface 108 may, in turn, be in communication with processor 102 to provide output to a user and, in some embodiments, to receive an indication of a user input. As such, the user interface 108 may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone, and/or the like. The processor 102 and/or user interface circuitry comprising the processor may be configured to control one or more functions of one or more user interface elements through computer program instructions (e.g., software and/or firmware) stored on a memory accessible to processor 102 (e.g., memory 104, and/or the like).

As noted previously, embodiments of the present invention comprise various means for extending the functional lifetime of at least one of the plurality of nodes comprising a gateway network. Below, further discussion is provided regarding several modes of operation of the various nodes within the gateway network, and example operations are described that may be performed by a gateway device to control the transition between modes of operation.

### Modes of Operation of a Gateway Network

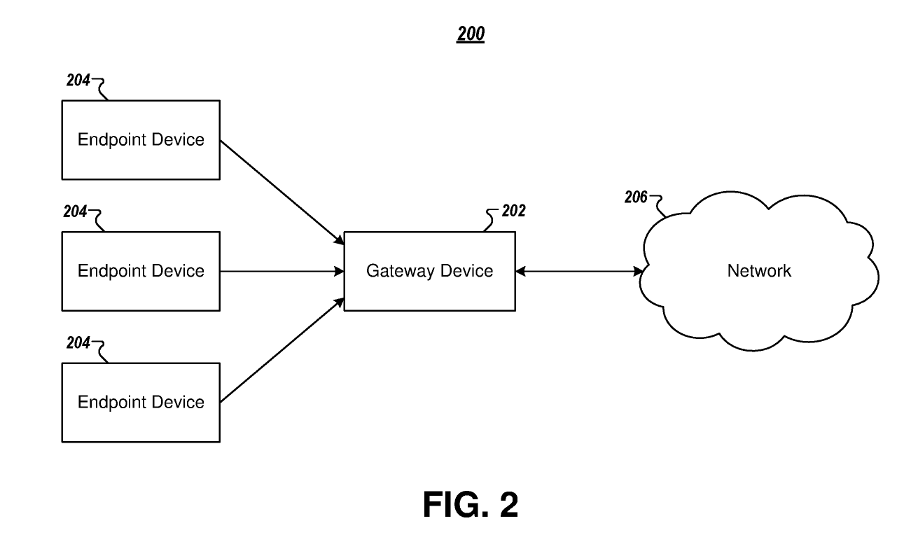

Turning now to FIG. 2, the schematic representation illustrates an example gateway network 200 operating in a normal mode of operation. As shown, endpoint devices 204 are in power-optimized mode, only waking up their radios when they have data to transmit. In some embodiments, this data can be sent by each endpoint device 204 to the gateway device 202 within the payload of a BLE advertisement packet. The endpoint devices 204 are configured to listen for incoming communication only briefly, often right after they have sent their packets. For instance, in this normal mode of operation, this listening can occur periodically, such as once every ten packets, once every few minutes, or at other periodic intervals as may be selected in a given embodiment. The purpose of brief listening windows is to allow the gateway device 202 to send something back (a connection request, a scan request, another advertisement such as a mode switch message, or the like) when needed, although sizeable transmissions are typically not expected in the normal mode of operation.

On the other hand, the gateway device 202 is listening continuously (or most of the time) to be able to capture endpoint devices' 204 packets at any time. This means that the gateway device 202 consumes quite a lot more power than the endpoint devices 204. The gateway device 202 also provides uplink connectivity to a separate network 206 (e.g., the Internet or another type of network). Without delving into the low-level details for establishing this connection to network 206, it should be understood that the gateway device 202 may, for instance, have a Wi-Fi™ or cellular uplink connection that is kept open either constantly or just when there is enough data to send forward.

When endpoint devices 204 communicate with the gateway device 202, they can indicate their respective capabilities to the gateway device 202. Alternatively, the gateway device 202 may also simply know the capabilities of the endpoint devices 204 from the initial configuration of the gateway network. In this regard, the endpoint devices 204 can transmit indications whether they support acting as pollable devices, as collector devices, or both. The endpoint devices 204 can also periodically indicate their battery power statuses to the gateway device 202, and the gateway device 202 can use this information to determine when it would be optimal for itself to switch into a power saving mode or not. It should be understood that the battery power status of an endpoint device may comprise a number of parameters regarding the battery of the endpoint device. These parameters may include battery power level of the endpoint device, the rate of battery power consumption of the endpoint device, and an estimate of the lifetime of the endpoint device's battery. In this regard, the gateway device 202 can make one decision based on an indication that an endpoint device has 25% of its battery power remaining, and a different device based on an indication of how long that 25% is expected to last. In some special cases, one or more of the endpoint devices 204 might be energy harvesting or even grid-powered, thus making them perfect for acting as collector device(s) in a different mode of operation of the gateway network. In such embodiments, the endpoint devices 204 may further be configured to transmit indications of these additional capabilities to the gateway device 202, and the gateway device 202 may further take these additional capabilities into account when determining an optimal mode of operation of the gateway network.

The gateway device 202, in turn, may determine the optimal mode of operation for the gateway network. In some embodiments, the gateway device 202 may continually recalculate this optimal mode of operation, although it should be understood that in some embodiments, the gateway device 202 may calculate the optimal mode of operation on a periodic basis, for instance, to conserve battery power. In determining the optimal mode of operation of the gateway network, the gateway device 202 may consider several factors: (a) its own battery level; (b) endpoint devices' capabilities and battery levels; and (c) which parts or functions within the gateway network are considered most critical. If, for instance, delivering a particular endpoint device's data to the Internet is identified as the most critical function, the gateway device 202 may configure the mode of operation of the nodes of the gateway network to automatically maximize the battery lifetime of that endpoint device at the expense of others.

To provide the necessary data to the gateway device 202 to manage the mode of operation of the gateway network, the endpoint devices 204 indicate their capabilities to the gateway device 202. This indication can signal whether a particular endpoint device 204 can act as a collector device, and may include statuses of the various endpoint devices 204, such as their respective battery power statuses or their various capabilities. The gateway device 202 can then utilize this information to choose whether one of the possible collector devices shall start acting as collector device, and informs that device when it needs to switch to operate in collector mode. Subsequently, as the gateway device 202 collects data from the collector device, the gateway device 202 can receive updates regarding the battery level of collector device and, of course, of the other endpoint devices 204. These updates then provide the information that can be used by the gateway device 202 to detect if there is a subsequent need to perform a change in the mode of operation or a change of the collector device, and then to orchestrate that change.

Based on the recalculation of the optimal mode of operation, the gateway device 202 may, at some point, decide that the normal operating mode is no longer optimal. This can happen, for instance, based on the battery level of the gateway device 202, the battery levels of the endpoint devices 204, based on a holistic analysis of the battery level of the gateway device 202 and the battery levels of one or more of the endpoint devices 204, and in some embodiments this determination may further be based on the capabilities of the endpoint devices 204 of the gateway network and/or the determination of the importance of various nodes of the gateway network. The gateway device 202 can instruct the endpoint devices 204 to switch from one mode to another by sending a transmission to each endpoint device 204, which in response can acknowledge the change by replying to the gateway device's request. While this transmission may be a BLE advertisement in some embodiments, the gateway device 202 may utilize other means of communicating with each endpoint device 204. For instance, the gateway device 202 may create a BLE connection with each endpoint device 204 and use a Generic Attribute Profile—or some other protocol—to tell the endpoint device 204 that it needs to switch modes.

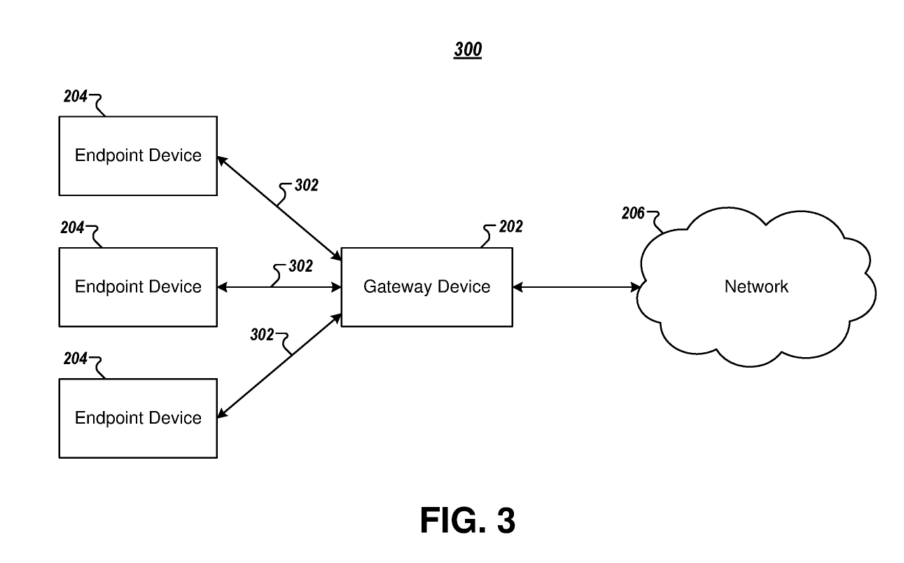

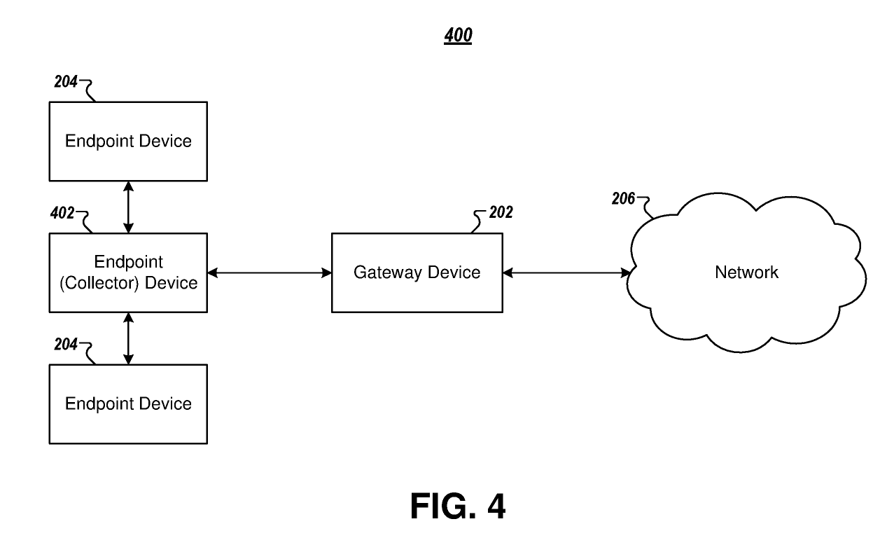

Turning now to FIGS. 3 and 4, example power saving modes of operation of the gateway network are described. In this regard, the first such power saving mode of operation is shown in FIG. 3, which illustrates a schematic representation of a gateway network 300 operating in a polling mode of operation. In this mode of operation, the gateway device 202 no longer continuously listens for incoming packets from the endpoint devices 204, and instead gathers data by polling the endpoint devices 204 individually. In this mode of operation, the gateway device 202 may ask—at its own pace—whether the endpoint devices 204 have data to transmit. By avoiding the need to constantly listen for transmissions from the endpoint devices 204, the gateway device 202 will thus save power. In this mode, however, the roles may, in part, been reversed, and the endpoint devices 204 listen for polling transmissions from the gateway device 202; thus, each endpoint device 204 operating in the polling mode of operation 300 consumes more power than it would in the normal mode of operation 200 described above in connection with FIG. 2. While the gateway device 202 can poll all endpoint devices 204 with a single BLE advertisement packet, the endpoint devices 204 respond individually. As show in FIG. 3, the communication channels 302 between each endpoint device 204 and the gateway device 202 are largely bidirectional communication channels (as opposed to the communication channels illustrated in FIG. 2, which are bidirectional for only very brief periods of time). It should be understood, however, that in the polling mode of operation, if the gateway device 202 polls an endpoint device 204 less frequently than the endpoint device 204 generates data, the endpoint device 204 may have to either store or drop some data.

Turning now to FIG. 4, the second power saving mode of operation is shown. In this regard, FIG. 4 illustrates a schematic representation of a gateway network 400 operating in a polling-from-collector mode of operation. To arrive at this mode of operation, the gateway device 202 must determine that at least one of the endpoint devices can act as a collector device 402, a determination that may be based in part on detecting that that endpoint device has sufficient battery power left to function in that role. In this mode of operation, the gateway device 202 instructs the selected endpoint device that it needs to switch into a collector role, and if the endpoint (collector) device acknowledges the request, the gateway device 202 can itself enter power-saving mode. Notably, the other endpoint devices 204 are not affected by the transition to polling-from-collector mode, and they can therefore transmit their data in the same fashion as they do in the normal mode of operation. However, instead of the gateway device 202 continually listening for transmissions from the other endpoint devices 204, in the polling-from-collector mode of operation, the continual listening is done by the collector device 402. The gateway device 202, in turn, can retrieve the data by polling the collector device 402, possibly using a BLE connection instead of using advertisements. In similar fashion as in the polling mode of operation described above, if the gateway device 202 polls the collector device 402 less frequently than the collector device 402 collects data from the other endpoint devices 204, then the collector device 402 will have to either store or drop some data.

The above description of the power saving modes of operation (shown in FIGS. 3 and 4) assume that the communication between endpoint devices 204 and the gateway device 202 happens via connectionless means, such as BLE advertisement packets. However, in other embodiments, these modes of operation may also be implemented using connection-oriented communication in cases where the connection endpoint devices 204 have asymmetric rates of power consumption (for instance due to asymmetric listening/sleeping duty cycles). In such embodiments, in the first power saving mode of operation (described in connection with FIG. 3), the connections between the gateway device 202 and each endpoint device 204 may be re-parameterized so that the endpoint devices 204, not the gateway device 202, carries the bigger burden for listening. In other such embodiments utilizing the second power saving mode of operation (described in connection with FIG. 4), the gateway device 202 would in addition need to instruct the normal endpoint devices 204 to disconnect themselves from the gateway device 202 and reconnect to the collector device 402.

### Operations Performed by a Gateway Device

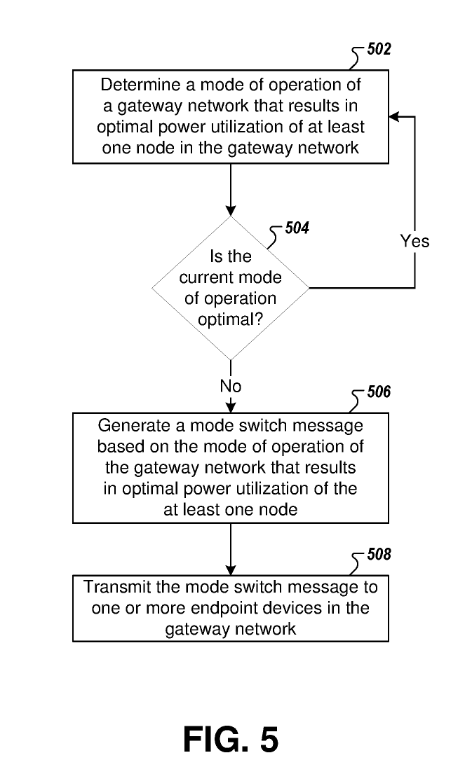

Having described several modes of operation of a gateway network, some example procedures will now be described that enable extension of the functional lifetime of at least one of the plurality of nodes of a gateway network. Turning to FIG. 5, a flowchart is illustrated that contains a series of operations performed by a gateway device 202 for optimizing the mode of operation of a gateway network. The operations illustrated in FIG. 5 may, for example, be performed by, with the assistance of, and/or under the control of apparatus 100 embodying a gateway device 202, and more particularly through the use of one or more of processor 102, memory 104, or communication interface 106.

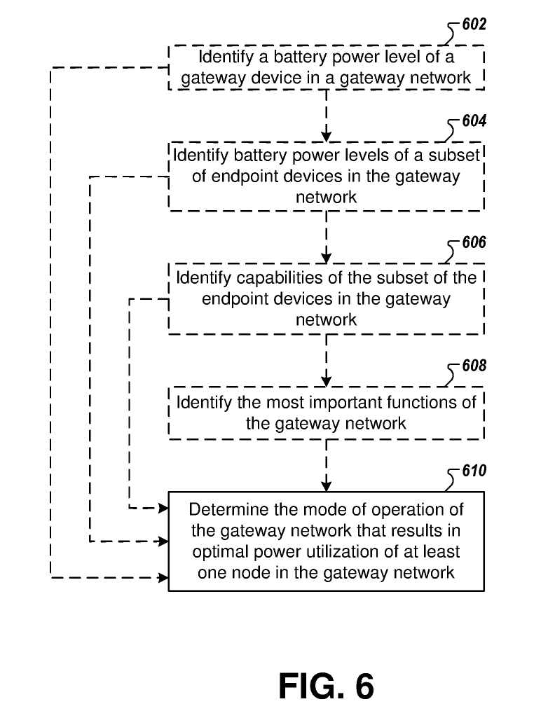

In operation 502 the apparatus 100 includes means, such as processor 102 or the like, for determining a mode of operation of the gateway network that results in optimal power utilization of at least one of the plurality of nodes. In this regard, this determination may be designed to identify the mode of operation that maximizes the battery life of one node within the gateway network (e.g., the gateway device itself or a particularly important endpoint device), a plurality of nodes within the gateway network, or even to maximize the collective lifetime of all of the nodes within the gateway network as a whole. It should be understood that the apparatus 100 may make this determination based on a variety of different considerations, as discussed at greater length below in connection with FIG. 6.

In operation 504, the apparatus 100 includes means, such as processor 102 or the like, for determining whether a current mode of operation of the gateway network comprises the mode of operation of the gateway network that results in optimal power utilization of at least one of the plurality of nodes. If the current mode of operation of the gateway network does comprise the mode of operation that results in optimal power utilization of at least one of the plurality of nodes, then the procedure may return to operation 502. In this regard, the gateway device may be configured to continually determine the optimal mode of operation of the gateway network, or alternatively the gateway device may determine the optimal mode of operation periodically or on an ad hoc basis in response to a trigger caused by receipt of updated information regarding one of the plurality of nodes of the gateway network.

Alternatively, if the current mode of operation does not comprise the mode of operation of the gateway network that results in optimal power utilization of at least one of the plurality of nodes, then the procedure advances to operation 506.

In operation 506 the apparatus 100 includes means, such as processor 102 or the like, for generating, by the processor of the gateway device, a mode switch message based on the mode of operation of the gateway network that results in optimal power utilization of the at least one of the plurality of nodes. The mode switch message may comprise an instruction designed for transmission to an endpoint device that instructs one or more endpoint devices to switch to an appropriate mode of operation (e.g., the mode of operation that results in optimal power utilization of the at least one of the plurality of nodes).

Finally, in operation 508 the apparatus 100 includes means, such as processor 102, communication interface 106, or the like, for causing transmission of the mode switch message to a first subset of the one or more endpoint devices. The endpoint devices included in the first subset may be selected by the apparatus 100 based on what mode of operation is determined to be optimal. If a polling mode of operation is determined to be optimal, this first subset may comprise all of the endpoint devices. In this regard, the mode switch message may comprise a single broadcast message transmitted to all of the endpoint devices to operate in polling mode. Alternatively, the mode switch message may be transmitted in a series of separate messages to each of the endpoint devices individually. As has been described previously, in the polling mode of operation, each endpoint device activates a receiver (e.g., a communications interface 106 of the endpoint device) to listen for polling transmissions from the gateway device.

If a polling-from-collector mode of operation is determined to be optimal, the first subset comprises a single target endpoint device, and the mode switch message instructs the target endpoint device to operate as a collector device (it should be understood that the other endpoint devices need not change their modes of operation if the gateway network is transitioning from a normal mode of operation, but that if the gateway network is transitioning from a polling mode of operation, it may be necessary for the gateway device to instruct the other endpoint devices to return from polling mode of operation to a normal mode of operation). As has been described previously, when operating as a collector device, an endpoint device activates a receiver (e.g., a communications interface 106 of the endpoint device) to listen for transmissions from all of the other endpoint devices within the gateway network. In addition, the endpoint device acting as a collector device is configured to transmit the collected data to the gateway device, in response to a polling message received from the gateway device via either a BLE connection or via an advertisement packet.

The apparatus 100 may include means, such as processor 102 or the like, for identifying this target endpoint device by analyzing the capabilities and the battery power statuses of one or more of the endpoint devices. The target endpoint device must both be capable of operating in collector mode and have a battery power level greater than a battery power threshold predetermined to be sufficient for a collector device. This identification may be based on data retrieved from the endpoint devices directly or based on historical data retrieved from the endpoint devices and stored in a memory (e.g., memory 104).

The mode switch message may be transmitted in response to identification of a suitable target endpoint device, or it may be transmitted only after analyzing the capabilities and battery power levels of all of the endpoint devices. One benefit of the latter approach is that the gateway device can identify an optimal endpoint from the entire set of endpoint devices.

Turning to FIG. 6, a flowchart is illustrated that contains a series of operations performed by a gateway device 202 for determining a mode of operation of the gateway network that results in optimal power utilization of at least one of the plurality of nodes. The operations illustrated in FIG. 6 may, for example, be performed by, with the assistance of, and/or under the control of apparatus 100 embodying a gateway device 202, and more particularly through the use of one or more of processor 102, memory 104, communication interface 106, or user interface 108.

In optional operation 602 the apparatus 100 includes means, such as processor 102, or the like, for identifying a battery power status of the gateway device (e.g., the apparatus 100 itself). A battery power status of a device may indicate at least one of a battery power level of the device, a rate of battery consumption of the device, or an estimated battery lifetime of the device. In this regard, the apparatus may further include means, such as processor 102 for determining whether the battery power level of the gateway device is below a first predetermined threshold. When the battery power level of the gateway device is below the first predetermined threshold, the apparatus 100 may determine that a power saving mode of operation will be optimal.

It should be understood that this first predetermined threshold may be set based on a number of factors. For example, one factor may be the required lifetime of the gateway. If the gateway device must retain enough battery power to last for one day, the gateway device's battery may be allowed to drain to a much lower level before switching into a power saving mode than if the same gateway device needs to survive with the same battery for 10 days. In extreme situation, the gateway could constantly be in a power saving mode and instruct some node to become collector. Practical examples that may be used for the predetermined threshold may include 50% or 20% of remaining battery power.

While the battery power levels of one or more of the plurality of nodes within the gateway network may decrease over time (e.g., as a natural result of continued use), power levels of one or more of the plurality of nodes may also increase in some circumstances (e.g., when a connects to a power source or when a node is configured to employ an energy harvesting function). For instance, if the battery power level of the gateway device 202 increases beyond a certain threshold while the current mode of operation of the gateway network is in either polling mode or polling-collector mode, the gateway device 202 may transmit a mode switch message to return to the normal mode of operation.

In optional operation 604 the apparatus 100 includes means, such as communication interface 106, or the like, for receiving one or more messages indicating battery power statuses of a subset of the one or more endpoint devices. As noted previously, the battery power status of a device may indicate at least one of a battery power level of the device, a rate of battery consumption of the device, or an estimated battery lifetime of the device. This subset of the one or more endpoints may include one of the endpoint devices, a plurality of the endpoint devices, or all of the endpoint devices.

In optional operation 606 the apparatus 100 includes means, such as processor 102, memory 104, communication interface 106, or the like, for identifying capabilities of a subset of the one or more endpoint devices. In some embodiments, the capabilities of the subset of the one or more endpoint devices are received directly from the subset of the one or more endpoint devices. In other embodiments, the capabilities are retrieved from a memory. These capabilities may include identifications of the modes of operation supported by the endpoint devices (e.g., whether the endpoint devices are capable of acting as pollable devices or as collectors), or identification of whether the endpoint devices are energy harvesting devices or are connected to the grid or to another power source.

In some embodiments, the capabilities may include various functions that might be performed by different endpoint devices in the gateway network. For instance, the size of an endpoint device's buffer (e.g., in bytes or number of messages) for storing collected data may be a relevant capability, because some endpoint devices can store larger amounts of data than other endpoint devices. Another capability could be the Received Signal Strength Indicator (RSSI) that tells the gateway device how far away the endpoint device is from the gateway device. Another capability might be an endpoint device's willingness to act as a collector device (which may be configurable or hard-coded). Yet another capability could be whether the endpoint device is stationary (fixed in one place) or mobile (moving). Another example capability might be the estimated remaining operational time of the endpoint device given the current energy consumption rate of the endpoint device.

In optional operation 608 the apparatus 100 includes means, such as processor 102, memory 104, communication interface 106, user interface 108, or the like, for identifying a set of most important functions of the gateway network. The set of most important functions may be predefined and stored in a memory, or may be received from a user in substantially real-time. Alternatively, the importance of the various functions of the endpoint devices may be predefined based on the nature of the functions, such that, for instance, devices having safety functions (e.g., a carbon monoxide detection) include a preset level of importance greater than, for instance, devices designed merely for convenience (e.g., automatic light switches). In some embodiments, the devices could indicate the importance themselves using values that can be based on the categories of the devices. For instance, there may be a set of prioritized categories, such as the following:
Life saving devices (EKG monitors, heart rate monitors)
Health monitoring devices (sugar levels)
Device monitors (ok, malfunction, needs attention)
Environment monitoring, high-priority (fire alarms)
Environment monitoring, low-priority (temperature)

Alternatively, there could be separate values for categories and for the priorities within those categories (some environment monitoring devices could have higher priority than some health monitoring devices, for example).

Finally, in operation 610 the apparatus 100 includes means, such as processor 102 or the like, for determining the mode of operation of the gateway network that results in optimal power utilization of at least one of the plurality of nodes. This determination may be based on the battery power level of the apparatus 100 (e.g., gateway device 202) itself, the battery power levels of a subset of the endpoint devices, the various capabilities of a subset of the endpoint devices, and the identified most important functions of the gateway network. Some or all of these points of information may be retrieved in optional operations 602-608 and subsequently utilized to calculate an optimal mode of operation of the gateway network. For instance, in some embodiments, the apparatus 100 may include means, such as processor 102 or the like, for generating ratios of the battery power level of the gateway device to the battery power levels of the subset of the one or more endpoint devices, and for determining whether one of the generated ratios is below a second predetermined threshold (which may, for instance, be preselected by a user). If one of the generated ratios is below the second predetermined threshold, the apparatus 100 may determine, for instance, that a polling-by-collector mode of operation is the optimal mode of operation.

Alternatively, in some embodiments, the apparatus 100 may include means, such as processor 102 or the like, for estimating these ratios (or estimating the lifetimes of the endpoint devices) based on energy consumption rates calculated from the catalog of battery power levels received from the various endpoint devices over time. Based on these estimated ratios (or lifetimes), the apparatus 100 may continually update the optimal mode of operation such that all nodes would run out of power at around the same time. To implement this feature, the gateway network may be switched to collector mode at the time that maximizes collective uptime of the gateway device and the endpoint devices willing to act as collectors. In some embodiments, this may mean that, when a grid-powered endpoint device is capable of acting as a collector, the gateway device could switch to polling-collector mode immediately and stay in such mode in perpetuity or until that endpoint device is no longer connected to the grid. Alternatively, if a collector device has a small (or partially drained) battery, the gateway device could switch to collector mode only when the gateway itself reaches a similar (or lower) battery power level.

As described above, example embodiments provide methods, apparatuses, and computer program products for optimizing operation of a gateway network, and more particular, for managing the battery power level of devices within the gateway network. Many IoT or body area networking systems are composed of endpoint devices and gateway devices, which are each battery powered. While they are traditionally optimized to save power in the endpoint devices at the expense of the gateway device, embodiments described herein enable other preferential choices to be made, depending on the goals and/or requirements of a particular system. In other words, a significant advantage provided by example embodiments described herein comprises the ability to dynamically change to the mode where gateway's power consumption is optimized, if appropriate. This can, as a result, enable the gateway network itself (or some particularly important nodes of the gateway network) to extend its lifetime despite the battery power constraints traditionally imposed on such networks.

In some cases, the gateway device and collector devices might be available as complementing device pairs. This can happen, for example, when a mobile phone is the gateway device and the user also has a smart watch that comprises one of the endpoint devices. Because the phone and watch are typically recharged daily, and often are very compatible (e.g., both may be Android devices), in some implementations contemplated herein, these devices may they share effort with each other using one or more of the modes of operation and/or operations described above. For example, the phone could order the smart watch to scan and collect data, and then the phone might periodically poll the readings from the watch. In this regard, such an embodiment would be even more useful when the watch is used for rendering some readings for the user to see and would thus separately benefit from acting as a collector of the sensory data from various other endpoint devices.

As described above, FIGS. 5 and 6 illustrate flowcharts describing the operation of an apparatus, method, and computer program product according to example embodiments of the invention. It will be understood that each flowchart block, and combinations of flowchart blocks, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus 100 employing an embodiment of the present invention and executed by a processor 102 of the apparatus 100. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will also be understood that one or more flowchart blocks, and combinations of flowchart blocks, can be implemented by special purpose hardware-based computer systems which preform the specified functions, or combinations of special purpose hardware and computer instructions.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-34. (canceled)

35. A method for saving power in a gateway network comprising a plurality of nodes including a gateway device and one or more endpoint devices, the method comprising:
determining, by a processor of the gateway device, a mode of operation of the gateway network that results in optimal power utilization of at least one of the plurality of nodes;
determining, by the processor of the gateway device, whether a current mode of operation of the gateway network comprises the mode of operation of the gateway network that results in optimal power utilization of at least one of the plurality of nodes; and
in response to determining that the current mode of operation of the gateway network does not comprise the mode of operation of the gateway network that results in optimal power utilization of at least one of the plurality of nodes,
generating, by the processor of the gateway device, a mode switch message based on the mode of operation of the gateway network that results in optimal power utilization of the at least one of the plurality of nodes, and
causing transmission of the mode switch message to a first subset of the one or more endpoint devices.

36. The method of claim 35, further comprising:
identifying, by the processor of the gateway device, a battery power status of the gateway device, wherein the battery power status of the gateway device indicates at least one of a battery power level of the gateway device, a rate of battery consumption of the gateway device, or an estimated battery lifetime of the gateway device,
wherein the determination of the mode of operation of the gateway network that results in optimal power utilization of the least one of a plurality of nodes is based on the identified battery power status of the gateway device.

37. The method of claim 36,
wherein, in an instance in which the battery power status of the gateway device indicates a battery power level of the gateway device, the determination of the mode of operation of the gateway network that results in optimal power utilization of the at least one of the plurality of nodes is further based on the indicated battery power level of the gateway device.

38. The method of claim 37, further comprising:
determining, by the processor of the gateway device, that the battery power level of the gateway device is below a first predetermined threshold,
wherein the determination of the mode of operation of the gateway network that results in optimal power utilization of the at least one of the plurality of nodes is further based on the determination the battery power level of the gateway device is below the first predetermined threshold.

39. The method of claim 36, further comprising:
receiving, by the communications circuitry of the gateway device, one or more messages indicating battery power statuses of a second subset of the one or more endpoint devices, wherein the battery power status of each particular endpoint device of the second subset of endpoint devices indicates at least one of a battery power level of the endpoint device, a rate of battery consumption of the endpoint device, or an estimated battery lifetime of the particular endpoint device,
wherein the determination of the mode of operation of the gateway network that results in optimal power utilization of the at least one of the plurality of nodes is further based on the received battery power statuses of the second subset of the one or more endpoint devices.

40. The method of claim 39, further comprising, in an instance in which the battery power status of the gateway device indicates a battery power level of the gateway device and the battery power statuses of the second subset of the one or more to endpoint devices indicate battery power levels of the second subset of the one or more endpoint devices:
generating ratios of the battery power level of the gateway device to the battery power levels of the second subset of the one or more endpoint devices; and
determining that at least one of the generated ratios of the generated ratios is below a second predetermined threshold,
wherein the determination of the mode of operation of the gateway network that results in optimal power utilization of the at least one of the plurality of nodes is further based on the determination that at least one of the generated ratios is below the second predetermined threshold.

41. The method of claim 35, further comprising:
identifying, by the gateway device, a set of most important functions of the gateway network,
wherein the determination of the mode of operation of the gateway network that results in optimal power utilization of the at least one of the plurality of nodes is further based on the identified set of the most important functions of the gateway network.

42. The method of claim 35, wherein the mode switch message instructs the first subset of the one or more endpoint devices to operate in polling mode.

43. An apparatus for saving power in a gateway network comprising a plurality of nodes including a gateway device and one or more endpoint devices, the apparatus comprising at least one processor and at least one memory including computer program code, the at least one memory and the computer program code configured to, with the at least one processor, cause the apparatus to:
determine a mode of operation of the gateway network that results in optimal power utilization of at least one of the plurality of nodes;
determine whether a current mode of operation of the gateway network comprises the mode of operation of the gateway network that results in optimal power utilization of at least one of the plurality of nodes; and
in response to determining that the current mode of operation of the gateway network does not comprise the mode of operation of the gateway network that results in optimal power utilization of at least one of the plurality of nodes,
generate a mode switch message based on the mode of operation of the gateway network that results in optimal power utilization of the at least one of the plurality of nodes, and
transmit the mode switch message to a first subset of the one or more endpoint devices.

44. The apparatus of claim 43, wherein the at least one memory and the computer program code are further configured to, with the at least one processor, cause the apparatus to:
identify a battery power status of the gateway device, wherein the battery power status of the gateway device identifies at least one of a battery power level of the gateway device, a rate of battery consumption of the gateway device, or an estimated battery lifetime of the gateway device,
wherein the at least one memory and the computer program code are further configured to, with the at least one processor, cause the apparatus to determine the mode of operation of the gateway network that results in optimal power utilization of the least one of a plurality of nodes based on the identified battery power status of the gateway device.

45. The apparatus of claim 44,
wherein, in an instance in which the battery power status of the gateway device indicates a battery power level of the gateway device, the at least one memory and the computer program code are further configured to, with the at least one processor, cause the apparatus to determine the mode of operation of the gateway network that results in optimal power utilization of the at least one of the plurality of nodes based on the indicated battery power level of the gateway device.

46. The apparatus of claim 45, wherein the at least one memory and the computer program code are further configured to, with the at least one processor, cause the apparatus to:
determine that the battery power level of the gateway device is below a first predetermined threshold,
wherein the at least one memory and the computer program code are further configured to, with the at least one processor, cause the apparatus to determine the mode of operation of the gateway network that results in optimal power utilization of the at least one of the plurality of nodes based further on the determination the battery power level of the gateway device is below the first predetermined threshold.

47. The apparatus of claim 44, wherein the at least one memory and the computer program code are further configured to, with the at least one processor, cause the apparatus to:
receive one or more messages indicating battery power statuses of a second subset of the one or more endpoint devices, wherein the battery power status of each particular endpoint device of the second subset of endpoint devices indicates at least one of a battery power level of the endpoint device, a rate of battery consumption of the endpoint device, or an estimated battery lifetime of the particular endpoint device,
wherein the at least one memory and the computer program code are further configured to, with the at least one processor, cause the apparatus to determine the mode of operation of the gateway network that results in optimal power utilization of the at least one of the plurality of nodes based further on the received battery power statuses of the second subset of the one or more endpoint devices.

48. The apparatus of claim 47, wherein the at least one memory and the computer program code are further configured to, with the at least one processor, cause the apparatus to, in an instance in which the battery power status of the gateway device indicates a battery power level of the gateway device and the battery power statuses of the second subset of the one or more to endpoint devices indicate battery power levels of the second subset of the one or more endpoint devices:
generate ratios of the battery power level of the gateway device to the battery power levels of the second subset of the one or more endpoint devices; and
determine that at least one of the generated ratios of the generated ratios is below a second predetermined threshold,
wherein the at least one memory and the computer program code are further configured to, with the at least one processor, cause the apparatus to determine the mode of operation of the gateway network that results in optimal power utilization of the at least one of the plurality of nodes based further on the determination that at least one of the generated ratios is below the second predetermined threshold.

49. The apparatus of claim 43, wherein the at least one memory and the computer program code are further configured to, with the at least one processor, cause the apparatus to:
identify capabilities of a third subset of the one or more endpoint devices,
wherein the at least one memory and the computer program code are further configured to, with the at least one processor, cause the apparatus to determine the mode of operation of the gateway network that results in optimal power utilization of the at least one of the plurality of nodes based at least in part on the identified capabilities of the third subset of the one or more endpoint devices.

50. The apparatus of claim 43, wherein the at least one memory and the computer program code are further configured to, with the at least one processor, cause the apparatus to:
identify a set of most important functions of the gateway network,
wherein the at least one memory and the computer program code are further configured to, with the at least one processor, cause the apparatus to determine the mode of operation of the gateway network that results in optimal power utilization of the at least one of the plurality of nodes based at least in part on the identified set of the most important functions of the gateway network.

51. The apparatus of claim 43, wherein the mode switch message instructs the first subset of the one or more endpoint devices to operate in polling mode.

52. The apparatus of claim 43,
wherein the first subset of the one or more endpoint devices comprises a target endpoint device, and
wherein the mode switch message instructs the target endpoint device to operate as a collector device.

53. The apparatus of claim 52, wherein the at least one memory and the computer program code are further configured to, with the at least one processor, cause the apparatus to:
identify that the target endpoint device is capable of acting as a collector device and that the target endpoint device has a battery power level greater than a battery power threshold, wherein the battery power threshold comprises a battery power level predetermined to be sufficient for a collector device,
wherein the at least one memory and the computer program code are further configured to, with the at least one processor, cause the apparatus to transmit the mode switch message to the target endpoint device in response to identifying that the target endpoint device is capable of acting as a collector device and that the target endpoint device has a battery power level greater than the battery power threshold.
